(19) United States
(12) Patent Application Publication
(10) Pub. No.: US 2004/0149369 A1
(43) Pub. Date: Aug. 5, 2004

(54) Production of regenerated leather by dry method

(76) Inventor: Shiyin Han, Zhejiang (CN)

Correspondence Address: KNOBBE MARTENS OLSON & BEAR LLP, 2040 MAIN STREET, FOURTEENTH FLOOR, IRVINE, CA, 92614, US

(21) Appl. No.: 10/480,219

(22) PCT Filed: Jun. 19, 2002
(86) PCT No.: PCT/CN02/00430

(30) Foreign Application Priority Data
Jul. 2, 2001 (CN) 01113748.7

(51) Int. Cl. B32B 35/00

(52) U.S. Cl. 156/94; 156/148

(57) ABSTRACT

The present invention relates to a process of production of regenerated leather with leather waste material. The process is characterized in comprising the following steps: (1) peeling off and producing fibers; (2) adding and mixing auxiliary materials; (3) layering by netting; (4) presetting by needle punching; (5) hot-melt adhering; (6) pressing and cooling. Compared with the conventional wet method, the process of the present invention has advantages of no pollution, low energy consumption, saving water and improved quality of the leather product.

### CROSS-REFERENCE TO RELATED APPLICATION

This application claims the benefit of Chinese Patent Application No. 01113748.7 filed on Jul. 2, 2001 in the State Intellectual Property Office of China, the disclosure of which is incorporated herein by reference.

### BACKGROUND OF THE INVENTION

1. Field of the Invention

The present invention relates to a process of production of regenerated leather with leather waste.

2. Description of the Related Art

Generally, the conventional process of production of regenerated leather is achieved by processing steps of the wet method in which a great quantity of water is consumed, thereby producing large amount of polluted water. Usually, eighty tons of polluted water shall be produced when one ton of leather is processed. Furthermore, the adhesives and other auxiliary materials used in this process are expensive, thus increasing the cost of the regenerated leather. Moreover, the processes of drying, sulphuration and heating result in increased power consumption. In addition, the finished leather produced by the conventional process has a poor quality and can only be used in low-class leather product.

### SUMMARY OF THE INVENTION

The present invention has been made to overcome the above mentioned disadvantages. Accordingly, it is an object of the present invention to provide a process of production of regenerated leather with no pollution, low energy consumption and improved quality of the leather product.

Additional aspects and advantages of the invention will be set forth in part in the description that follows, and in part, will be obvious from the description, or may be learned by the practice of the invention.

The forgoing and other aspects of the present invention are achieved by providing a process of production of regenerated leather, comprising the following steps: (1) peeling off and producing fibers; (2) adding and mixing auxiliary materials; (3) layering by netting; (4) presetting by needle punching; (5) hot-melt adhering; (6) pressing and cooling.

Preferably, the auxiliary materials are thermoplastic fibers and the weight of that amount to 10%-30% of the total weight of the mixture of the auxiliary materials and leather materials.

Preferably, the step of peeling off and producing leather fibers is performed in a leather loosening and peeling off unit so that the leather raw materials supplied therein is loosened and peeled off.

Preferably, a roller with steel needles arranged throughout the outer circumference thereof is disposed inside of the leather loosening and peeling off unit, and the supplied leather is peeled off into fiber strips due to operation of steel needles arranged in the roller rotated in high speed.

Preferably, the step of peeling off and producing leather fibers further comprises a step of refining the leather fiber strips.

Preferably, the step of refining the leather fiber steps is performed in an air blowing unit so that the leather fiber strips are refined.

Preferably, the leather raw materials after being processed by the loosening and peeling off unit are supplied into an air blowing selection unit in which the fiber strips with different density are separated by the air force generated by the air blowing selection unit.

Preferably, the step of adding auxiliary materials and mixing is performed in a mixing unit so that the thermoplastic fibers are added into the leather fiber strips to make a mixture.

Preferably, the thermoplastic fibers are evenly distributed in the leather fiber strips.

Preferably, the step of layering by netting is performed in a netting unit so that the mixture is formed into a layer of fiber strips.

Preferably, the step of presetting by needle punching is performed in a presetting and needle punching unit so that the layer of netting fibers punched by the needles has a predetermined strength.

Preferably, the step of heat-melt adhering step is performed in a heating unit so that the leather fibers are bonded together.

Preferably, when the temperature in the heating unit reaches the melting point of the thermoplastic fibers, the thermoplastic fibers in the layer of netting fibers melt so that leather fibers are bonded together.

Preferably, the heating unit may be a heating oven.

Preferably, the step of pressing and cooling is performed by a pressing roller in which the layer of netting fibers after being removed from the heating unit is pressed so as to form a densified layer of netting fibers.

Preferably, the densified layer of netting fibers after being pressed by the pressing roller is cooled and hardened so that regenerated leather is obtained.

Compared with the process of production of regenerated leather by conventional wet method, the process of the present invention has the following advantages.

Firstly, water is used throughout the whole process of production of regenerated leather by conventional wet method. For example, if 1 ton of regenerated leather is produced by a conventional long-mesh machine, 80 tons of water will be used, thus producing 80 tons of polluted water. By contrast, the process of the present invention does not produce waste water.

Secondly, because a great quantity of moisture, such as 50%, is contained in the raw materials for regenerated leather after being squeezed, the power consumption increases when the raw materials are heated so that the percentage of moisture contained in the finished product decreases to 10%, thus a great amount of power is consumed. By contrast, the power consumption is greatly reduced in the process of the present invention.

Thirdly, the weight of the latex used as adhesive in the conventional wet method amounts to 50% of the total weight of the regenerated leather and a great deal of auxiliary materials are also required. By contrast, thermoplastic fibers are used as adhesive in the process of present invention and the weight of the thermoplastic fibers amount to 10%-30% of the total weight of the regenerated leather. In addition, no more auxiliary materials are required in the process of present invention, thus reducing the cost of the regenerated leather.

Fourthly, the phenomenon of flocculation occurs in the slurry if the leather fibers are too long in the conventional wet method, therefore, the length of the fibers is limited in 3-8 mm. As a result, the internal aggregation force is not sufficient as the fibers are too short, thus degrading the physical characteristics of the finished product. By contrast, the length of the fibers in the process of the present invention is not limited. Accordingly, the physical characteristics of the finished product of the present invention are superior to that of the conventional wet method.

Fifthly, there have been no breakthrough and development in the process of production of regenerated leather by wet method in the past decades. As a result, the finished products of the conventional wet method are used only in low-class products. In the present invention, many new kinds of technology such as the needle punching technology applied in the non-weaving clothing field, the technology of layering by netting and heat-melt adhering are applied in the process of production of regenerated leather. Accordingly, the quality of the finished product is greatly improved so as to meet the high-class requirements in the industries of shoemaking, case-making and leather-laminating.

### BRIEF DESCRIPTION OF THE DRAWINGS

The above and other objects and advantages of the invention will become apparent and readily appreciated from the following description of the preferred embodiments, taken in conjunction with the accompanying drawings, in which:

FIG. 1 is a schematic view of process flowchart according to an embodiment of present invention.

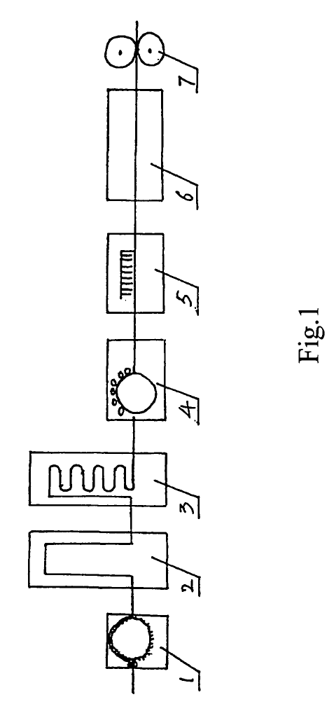

### DETAILED DESCRIPTION OF THE PREFERRED EMBODIMENTS

A preferred embodiment of the present invention will be described hereinafter in detail with reference to the attached drawings, wherein the like reference numerals refer to the like elements throughout the specification. The present invention may, however, be embodied in many different forms and should not be construed as being limited to the embodiment set forth herein; rather, this embodiment is provided so that the present disclosure will be thorough and complete, and will fully convey the concept of the invention to those skilled in the art.

A process of production of regenerated leather which is used in a mid-soles of the shoes is illustrated in an embodiment of the present invention. Firstly, raw materials for the regenerated leather in different color and different thickness are selected manually from leather waste materials. Next, the selected raw materials are supplied into a leather loosening and peeling off unit 1. A roller with steel needles arranged throughout the outer circumference thereof is disposed inside of the leather loosening and peeling off unit 1. The supplied leather is peeled off into fiber strips due to operation of steel needles arranged in the roller rotated in high speed. The leather materials processed by the leather loosening and peeling off unit 1 are substantially loosened and peeled off. Meanwhile, little pieces of leather without being peeled off and leather powder being crushed are still mixed with the leather materials processed by the leather loosening and peeling off unit 1.

Then, the leather materials processed by the leather loosening and peeling off unit 1 are supplied to an air blowing selection unit 2. At this time, the fiber strips with different density are separated by the air force generated by the air blowing selection unit 2. The selected fiber strips are supplied to a mixing unit 3 in which thermoplastic fibers are added as auxiliary materials and mixed evenly with the supplied leather materials the weight of the auxiliary materials amount to 10%-30% of the total weight of the mixture of the auxiliary materials and leather materials. Thereafter, the mixed materials are transferred to a netting unit 4. The mixed materials are carded and mixed, and impurity matters are removed from them.

Then, the processed materials are subject to the netting step so as to form a layer of netting fibers for producing regenerated leather. Next, the layer of netting fibers is supplied to a presetting and needling punching unit 5 to be punched by needles so that the layer have a predetermined strength. Thereafter, the layer of netting fibers are transferred into a heating unit 6, such as a heating oven. When the temperature in the heating unit 6 reaches the melting point of the thermoplastic fibers, the thermoplastic fibers in the layer of netting fibers melt so that leather fibers are bonded together.

Next, the layer of netting fibers is removed from the heating unit 6 and supplied to a pressing roller 7. Then, the layer of netting fibers is pressed by a pressing roller 7 so that the loose layer of netting fibers transforms into a densified layer of netting fibers. At the end, the pressed leather layer is cooled down and hardened, thus the process of production of regenerated leather is completed.

Although a preferred embodiment has been shown and described, it would be appreciated by those skilled in the art that changes may be made in these embodiments without departing from the principles and spirit of the invention, the scope of the which is defined in the claims and their equivalents.

1. A process of production of regenerated leather by dry method, the process comprising the steps of: (1) peeling off and producing leather fibers; (2) adding and mixing auxiliary materials; (3) layering by netting; (4) presetting by needle punching; (5) hot-melt adhering; and (6) pressing and cooling.

2. The process of production of regenerated leather by dry method according to claim 1, wherein said auxiliary materials are thermoplastic fibers and the weight of the auxiliary materials amount to 10%-30% of the total weight of the mixture of the auxiliary materials and leather materials.

3. The process of production of regenerated leather by dry method according to claim 1 or 2, wherein said step of peeling off and producing leather fibers is performed in a leather loosening and peeling off unit so that the leather raw materials supplied therein is loosened and peeled off.

4. The process of production of regenerated leather by dry method according to claim 3, wherein a roller with steel needles arranged throughout the outer circumference thereof is disposed inside of the leather loosening and peeling off unit, and the supplied leather is peeled off into fiber strips due to operation of steel needles arranged in the roller rotated in high speed.

5. The process of production of regenerated leather by dry method according to claim 4, wherein the step of peeling off and producing leather fibers further comprises a step of refining the leather fiber strips.

6. The process of production of regenerated leather by dry method according to claim 5, wherein the step of refining the leather fiber steps is performed in an air blowing unit so that the leather fiber strips are refined.

7. The process of production of regenerated leather by dry method according to claim 6, wherein the leather raw materials after being processed by the loosening and peeling off unit are supplied into an air blowing selection unit in which the fiber strips with different density are separated by the air force generated by the air blowing selection unit.

8. The process of production of regenerated leather by dry method according to claim 5, wherein the step of adding auxiliary materials and mixing is performed in a mixing unit so that the thermoplastic fibers are added into the leather fiber strips to make a mixture.

9. The process of production of regenerated leather by dry method according to claim 6, wherein the step of adding auxiliary materials and mixing is performed in a mixing unit so that the thermoplastic fibers are added into the leather fiber strips to make a mixture.

10. The process of production of regenerated leather by dry method according to claim 9, wherein the thermoplastic fibers are evenly distributed in the leather fiber strips.

11. The process of production of regenerated leather by dry method according to claim 8, wherein the step of layering by netting is performed in a netting unit so that the mixture is formed into a layer of fiber strips.

12. The process of production of regenerated leather by dry method according to claim 10, wherein the step of layering by netting is performed in a netting unit so that the mixture is formed into a layer of netting fibers.

13. The process of production of regenerated leather by dry method according to claim 11, wherein the step of presetting by needle punching is performed in a presetting and needle punching unit so that the layer of netting fibers punched by the needles has a predetermined strength.

14. The process of production of regenerated leather by dry method according to claim 13, wherein the step of heat-melt adhering step is performed in a heating unit so that the leather fibers are bonded together.

15. The process of production of regenerated leather by dry method according to claim 14, wherein:
when the temperature in the heating unit reaches the melting point of the thermoplastic fibers, the thermoplastic fibers in the layer of netting fibers melt so that leather fibers are bonded together.

16. The process of production of regenerated leather by dry method according to claim 15, wherein the heating unit comprises a heating oven.

17. The process of production of regenerated leather by dry method according to claim 14, wherein the step of pressing and cooling is performed by a pressing roller in which the layer of netting fibers after being removed from the heating unit is pressed so as to form a densified layer of netting fibers.

18. The process of production of regenerated leather by dry method according to claim 17, wherein the densified layer of netting fibers after being pressed by the pressing roller is cooled and hardened so that regenerated leather is obtained.
